(19) United States
(12) Patent Application Publication
(10) Pub. No.: US 2004/0100179 A1
(43) Pub. Date: May 27, 2004

(54) Spark plug having an encapsulated electrode gap

(76) Inventors: William C. Boley, Lafayette, IN (US); Gary P. Mueller, Lafayette, IN (US); Jason L. Niethammer, Lafayette, IN (US); James M. Schultz, Chillicothe, IL (US); Brady L. Winkleman, Lafayette, IN (US)

Correspondence Address: CATERPILLAR INC., 100 N.E. ADAMS STREET, PATENT DEPT., PEORIA, IL, 616296490

(21) Appl. No.: 10/303,562

(22) Filed: Nov. 25, 2002

(51) Int. Cl. H01T 13/20

(52) U.S. Cl. 313/143

(57) ABSTRACT

Spark plugs in an internal combustion engine may have an encapsulated spark gap allowing for improved emissions and efficiency. However, increased temperatures in an ignition chamber about the spark gap may cause pre-ignition of a air fuel mixture in a combustion chamber. A purge passage allows hot exhaust gas to be expelled from the ignition chamber and thus reduce likelihood of pre-ignition.

### TECHNICAL FIELD

This invention relates generally to a spark ignition device for an internal combustion engine and more particularly to an encapsulated spark plug.

### BACKGROUND

Emissions and efficiency continue driving technology to improve combustion of air and fuel mixtures. Many improvements have come through greater control of air flows and fuel flows. Generally, these controls have improved atomization and mixing of the fuel and air.

Spark ignited engines may additionally control a combustion event through initiation of a spark. Encapsulated spark plugs combine improvements gained by improving mixing of fuel and air along with improvements gained by controlling initiation of the spark. An encapsulated spark plug includes an ignition chamber defined by an interior portion of the plug shell. The ignition chamber surrounds an electrode gap between a first electrode and a second electrode. As a piston compresses an air/fuel mixture in the combustion chamber, at least a portion of the air/fuel mixture passes through an orifice in the plug shell into the ignition chamber.

In the ignition chamber, a spark across the electrode gap causes the portion of air/fuel mixture to combust resulting in a pressure rise in the ignition chamber. Hot gasses escape from ignition chamber into the air/fuel mixture in the combustion chamber as the pressure in the ignition chamber overcomes pressures in the combustion chamber. The hot gasses act like a torch penetrating further into the combustion chamber than a typical spark plug. Further penetration by the torch causes combustion to occur more evenly throughout the combustion chamber to reduce a mass of unburned air/fuel mixture. Both U.S. Pat. No. 4,937,868 issued 29 Jan. 1991 and U.S. Pat. No. 5,105,780 issued 21 Apr. 1992 to Richardson show encapsulated spark plugs.

Operating the encapsulated spark plugs may require higher temperatures resulting in pre-ignition of the fuel/air mixture. In general, electrical demands are greater than those in a standard spark plug. These higher electrical demands may cause the encapsulated spark plugs to operate at higher temperatures. Pre-ignition of the fuel/air mixture in the ignition chamber may occur at these higher temperatures. U.S. Pat. No. 6,460,506 issued to Nevinger on Oct. 8, 2002 discloses one aspect of increased temperatures as being an increased heat transfer resistance between a tip portion of a spark plug shell and the cylinder head. In Nevinger, the assignee (the same as in the present case) attempts to reduce the temperature at an orificed region by increasing heat transfer to the cylinder head.

The present invention is directed to overcoming one or more of the problems as set forth above.

### SUMMARY OF THE INVENTION

In an embodiment of the present invention a spark plug has a spark plug shell. An insulator is placed in an interior portion of the spark plug shell with a first electrode passing through the insulator.

An end cap connects with the spark plug shell. A second electrode connects with at least one of the end cap or spark plug shell. The spark plug shell, end cap and insulator define an ignition chamber including a purge portion above an ignition plane. A purge passage fluidly connects the purge portion with a combustion chamber.

In another embodiment of the present invention an end cap for a spark plug includes a first end portion, second end portion, interior portion, and exterior portion. The first end portion connects with a spark plug shell. An ignition plane is formed between the first end portion and the second end portion. A purge passage fluidly connects the interior portion at or above the ignition plane with the exterior portion. A second passage connects the interior portion with the exterior portion at or near the second end portion.

Further, the present invention may also be characterized as a method of reducing pre-ignition in a spark plug where a mixture of fuel and air are introduced into an ignition chamber of a spark plug. The fuel and air are ignited in an ignition plane of the spark plug. At least a portion of the combustion gas is expelled into the combustion chamber through a jet passage. Another portion of the combustion gas is expelled from a purge portion of the ignition chamber where the purge portion is a volume at or above the ignition plane.

### BRIEF DESCRIPTION OF THE DRAWINGS

FIG. 1 is a cross section view of a spark ignited internal combustion engine including a spark plug having an embodiment of the present invention;

FIG. 2 is a cross-sectional view of a spark plug having an embodiment of the present invention; and

FIG. 3 is a cross-sectional view of a spark plug having an alternative embodiment of the present invention.

### DETAILED DESCRIPTION

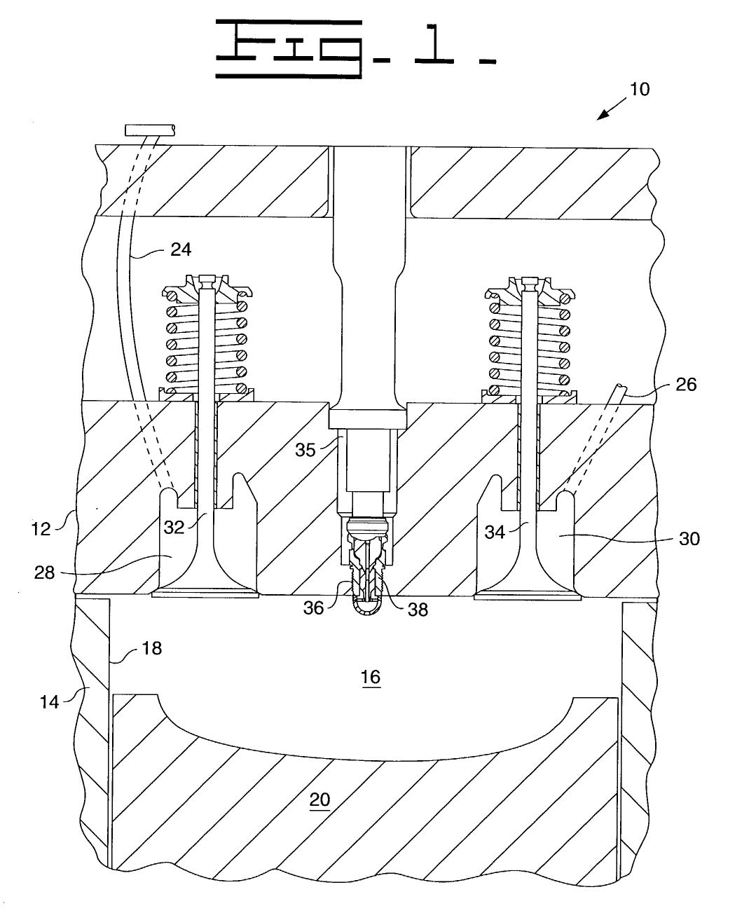

In FIG. 1 a spark ignited combustion engine 10 has a cylinder head 12 sealingly connecting with a cylinder block 14. A combustion chamber 16 is defined by a cylinder wall 18 in the cylinder block 14, the cylinder head 12, and a piston 20. The piston 20 slidingly engages the cylinder wall 18 in a conventional manner.

The cylinder head 12 has at least one port (not shown) fluidly connecting the combustion chamber 16 with a fuel conduit (not shown), an inlet conduit 24, and an exhaust conduit 26. For this application, the engine 10 has a first inlet port 28, a second inlet port (not shown), a first exhaust port 30, and a second exhaust port (not shown). The inlet ports 28 fluidly connect to the inlet conduit 24. The exhaust ports 30 fluidly connect to the exhaust conduit 26. While the fuel conduit may connect directly with the combustion chamber 16, this application has the fuel conduit connecting with inlet conduit 24 upstream of the inlet port 28. An inlet valve 32 is movably positioned in the inlet port 28 and an exhaust valve 34 is movably positioned in the exhaust port 30. The engine may have multiple inlet valves 32 and exhaust valves 34 for each combustion chamber 16. Each engine 10 may have multiple combustion chambers 16 arranged in numerous manners such as inline, V, flat, or radial configurations.

The cylinder head 12 further includes a spark plug well 35 having a connection portion 36. In this application, the connection portion 36 is threaded. However, the connection portion 36 may be any conventional connection mechanism able to withstand pressures, temperatures, and chemistry compatibility typical of a combustion process. The spark plug well 35 may also include cooling channels (not shown). A spark plug 38 sealingly connects with the cylinder head 12.

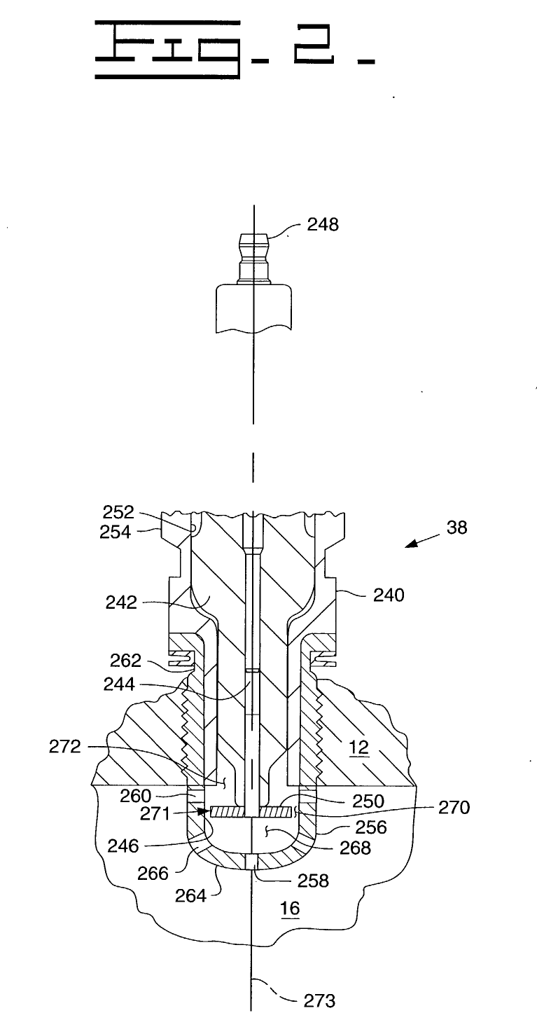

FIG. 2 shows the spark plug 38 having a spark plug shell 240, insulator 242, first electrode 244, and a second electrode 246. The first electrode 244 has a first portion 248 for connecting with a power source (not shown) and a second portion 250 distal from the first portion. The first electrode 244 may be made of a material having good electrical conductivity and heat resistance such as a nickel alloy. The insulator 242 electrically isolates the first electrode 244 from the second electrode 246 while still maintaining structural integrity in a high temperature environment. The insulator 242 may be made of a ceramic. The insulator 242 connects with and generally covers the first electrode 244 between the first portion 248 and second portion 250.

The spark plug shell 240 has an interior portion 252 and exterior portion 254. The interior portion 252 of the spark plug shell 240 is adjacent to the insulator 242. The exterior portion 254 of the spark plug shell 240 is positioned in the spark plug well 35 in a conventional manner.

In the present embodiment, an end cap 256 is connected with the spark plug shell in a conventional manner such as press fitting or welding. The end cap 256 may include a jet passage 258, a purge passage 260, a first end portion 262, and a second end portion 264. The first end portion 262 is above the second end portion 264 and proximate the cylinder head 12. For this application, “above” means the first end portion 262 is closer to the first portion 248 of the first electrode 244 compared with the second end portion 264. The jet passage 258 may be a single orifice below the first electrode 250. In this embodiment, the jet passage 258 includes multiple orifices 266. Preferably the multiple orifices 266 are angled at least partially toward the piston 20 or downward.

Connecting the end cap 256 with the spark plug shell 240 forms an ignition chamber 268. The end cap 256 may act as the second electrode 246 as shown. An ignition plane 270 is formed generally about a spark gap 271 between the second portion 250 of the first electrode 244 and the second electrode 246. The “plane” is generally perpendicular to a longitudinal axis 273 between the first portion 248 and second portion 250 of the first electrode 244. The “plane” may have a thickness perpendicular to the “plane” equivalent a longitudinal length of the spark gap 271. A purge portion 272 of the ignition chamber 268 is formed at or above the ignition plane 270. The purge passage 260 fluidly connects the purge portion 272 with the combustion chamber 16. Alternatively, the purge passage 260 may also be connected with an external gas source or sink such as atmosphere, a suction line, or a compressed air line.

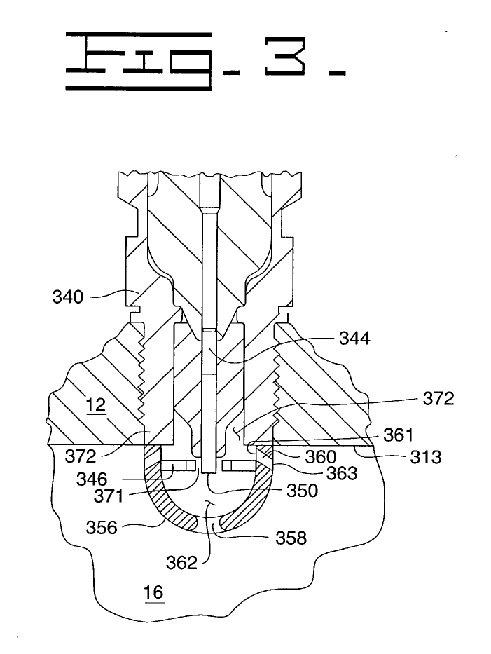

In an alternative embodiment shown in FIG. 3, the end cap 356 is integral with the spark plug shell 340. For this embodiment, the element numbering starts with a “3” instead of “2” to reflect alternative embodiments of similar elements. The end cap 356 includes a single jet passage 358 positioned below the second portion 350 of the first electrode. The end cap 356 may be hemispherical. The end cap 356 may be integral with the spark plug shell 340 or attached to the spark plug shell in a conventional manner such as press fitting, threading, or welding. The second electrode 346 is connected to the spark plug shell 340 to form a spark gap 371 with the second portion 350 of the first electrode 344. The purge passage 360 has a first end 361 above a second end 363. The first end 361 is adjacent the purge portion 372 and the second end 363 is adjacent the combustion chamber 16. The first end 361 may also be at or above a bottom portion 313 of the head 12 where “bottom” means the portion adjacent the block 14. As shown in this embodiment, multiple purge passages 360 may be used. Further, the purge passages 360 may be angled with respect to both the longitudinal axis and with respect to a radius of the spark plug shell 340.

### INDUSTRIAL APPLICABILITY

As pressures rises in the combustion chamber 16, a portion combustion gas may remain in the ignition chamber 268 if no purge passage 260 is provided. These residual gasses may contribute to pre-ignition of the ignition chamber 268 as well as problems starting a cold engine. In a cold engine, the residual gasses may contain vapor that condenses out as water droplets as the engine cools. Vapor may pose a problem with re-starting the engine.

Using the purge passage 260 promotes exchange of gasses with the combustion chamber 16. Movement of the piston 20 through its exhaust stroke causes combustion gasses to move through the jet passage 258 into the ignition chamber 268. As pressures rises again in the ignition chamber 268 during a compression stroke, a fresh charge mixture passes through the purge portion 272 as residual gasses escape through the purge passage 260. The fresh charge typically is cooler than the residual gasses during normal engine operation. The fresh charge mixture may also pass through the purge passage 260 during the induction stroke. The purge portion 272 in particular will have a gas composition and temperature similar to that of the rest of the ignition chamber 268 including lower temperatures.

Using the purge passage in FIG. 3, the purge passage 360 additionally allows a larger volume of the purge portion 272 to be in contact with the cylinder head 12 to enhance heat transfer. Using multiple, angled purge passages 360 may enhance mixing of gasses within the purge portion 272 and further reduces likelihood of pre-ignition of the ignition chamber 272 by the residual gasses.

Other aspects, objects, and advantages of this invention can be obtained from a study of the drawings, the disclosures, and the appended claims.

What is claimed is:

1. A spark plug comprising:
a spark plug shell having an interior portion and exterior portion;
an insulator being adjacent said interior portion of said spark plug shell;
a first electrode being positioned adjacent said insulator, said first electrode having a first portion distal from a second portion;
an end cap being connected with said spark plug shell;
a second electrode being connected with at least one of said end cap and said spark plug shell, said second portion of said first electrode and said second electrode being adjacent;
an ignition chamber being defined by said spark plug shell, said end cap, and said insulator;
a purge portion of said ignition chamber being defined generally as a volume of said ignition chamber at or above said ignition plane; and
a purge passage being adapted to fluidly connect said purge portion with a combustion chamber, said purge passage having a first end adjacent said purge portion and a second end adjacent said combustion chamber.

2. The spark plug as in claim 1 wherein said end cap is integral with said spark plug shell.

3. The spark plug as in claim 1 wherein said end cap is press fit to said spark plug shell.

4. The spark plug as in claim 1 wherein said end cap has a hemispherical second end.

5. The spark plug as in claim 1 wherein said end cap includes a jet passage.

6. The spark plug as in claim 1 wherein said purge passage is generally parallel with the ignition plane.

7. The spark plug as in claim 6 wherein said purge passage is above said ignition plane.

8. The spark plug as in claim 1 wherein said first end of said purge passage is above said ignition plane.

9. The spark plug as in claim 1 wherein said second electrode is integral with at least one of said end cap and said spark plug shell.

10. An end cap for a spark plug, said end cap, said spark plug including a spark plug shell and ignition chamber, said end cap comprising:
a first end portion;
a second end portion distal from said first end portion, said first end portion being connectable with said spark plug shell;
an ignition plane between said first end portion and said second end portion;
a purge passage being adapted to connect fluidly connect said ignition chamber with a combustion chamber, said purge passage having a first end adjacent said ignition chamber, said first end being between said ignition plane and said first end portion; and
a jet passage through said second end portion.

11. The end cap as in claim 10 wherein said purge passage is angled such that a second end of said purge passage is closer to said second end portion than said first end of said purge passage is to said second end portion.

12. A method of reducing pre-ignition in a spark plug, said method comprising:
introducing a mixture of fuel and air into an ignition chamber of the spark plug;
igniting the mixture of fuel and air to form a combustion gas in an ignition plane;
expelling at least a portion of the combustion gas through a jet passage into a combustion chamber; and
purging combustion gas from a purge portion of said ignition chamber wherein said purge portion being at or above the ignition plane.

13. The method of reducing pre-ignition as in claim 12 wherein said purging includes introducing a gas into the purge portion.

14. The method of reducing pre-ignition as in claim 13 including introducing the gas through the jet passage.

15. The method of reducing pre-ignition as in claim 13 including cooling the gas to a temperature below the combustion gas in the purge portion prior to introducing the gas into the purge portion.

16. The method of reducing pre-ignition as in claim 13 including expelling combustion gas through a purge passage being fluidly connected with a combustion chamber.

17. The method of reducing pre-ignition as in claim 12 including imparting a rotational motion to the gas.
